(19) United States
(12) Patent Application Publication
(10) Pub. No.: US 2006/0224501 A1
(43) Pub. Date: Oct. 5, 2006

(54) Online loan qualification and processing method

(76) Inventor: Jeff M. Louis, Spring, TX (US)

Correspondence Address: Mark A. Tidwell;Jackson Walker L.L.P., Suite 2400, 112 E. Pecan Street, San Antonio, TX, 78205-1521, US

(21) Appl. No.: 11/386,607

(22) Filed: Mar. 22, 2006

Related U.S. Application Data
(60) Provisional application No. 60/664,264, filed on Mar. 22, 2005.

(51) Int. Cl. G06Q 40/00

(52) U.S. Cl. 705/38

(57) ABSTRACT

A method by which a consumer can directly manage a loan application process over the Internet from the initial request to final closing. The overall process is automatically driven by the progressive collection of consumer data and the completion of tasks provided to the consumer. The tasks are compiled in a task database and the particular tasks for a particular loan application are generated based on the data received from the consumer. Moreover, the method consists of at least two interactive stages, namely a qualifying stage and a processing stage. During each stage, the consumer provides progressively more detailed consumer information. During each stage, the information collected from the consumer is analyzed to determine the sufficiency of the information. Based on the analyzed data, task lists are generated to prompt the consume to provide the requested data thereby completing the task.

The present application claims priority to U.S. provisional patent application No. 60/664,264 filed on Mar. 22, 2005.

### BACKGROUND OF THE INVENTION

The present invention relates to the field of mortgage loan processing. More particularly, the invention relates to a method by which consumers for a loan such as a mortgage can interactively and directly manage the entire loan process without the need for intermediary brokers.

In the traditional consumer loan application process, a consumer applies for a loan through a financial services institution such as a bank, a mortgage banker or a mortgage broker. In each case, the loan application is managed by a loan officer who performs various activities necessary to process the loan from application to closing. These various activities may include the evaluation of the loan, the collection of data necessary to process the loan, selection of an interest rate, the selection of a closing date, the selection of an appraisal company, the selection of a survey company, the selection of a home owner's insurer, the selection of a title company, the selection of a particular financial institution to fund the loan, and communication with all of the foregoing entities. Because of the constant flow of data that is typically required during the application process, the number of external entities that may be involved in the process, and the need for an in-depth understanding of the loan process in order to manage all of the foregoing, a loan officer was a necessity. Moreover, the entire loan process can be very intimidating to consumers who have little knowledge of the process, made even more intimidating by the amount of funds involved in the loan. In any even, for these various services performed by the loan officer, the financial services institution generally receives a fee based on the loan amount.

One drawback to the foregoing traditional process is that a consumer typically has very little input with regard to these various loan officer managed activities. For example, a title company is often selected without consultation with the consumer. Likewise, while any number of financial institutions may be available to fund a loan, a loan officer will typically select a financial institution based on factors unrelated to the consumer, such as an existing working relationship between the loan officer and the financial institution.

Of course, an additional drawback to the involvement of an intermediary loan broker is that the consumer must pay the broker's fee in addition to the other costs associated with the application.

With the proliferation of the Internet, the ability to more easily manage data, and the willingness of consumers to perform certain activities, the need for traditional “broker” or intermediary services in certain industries has diminished. For example, the purchase of airline tickets, vacation planning or the trading of securities are all common place on-line activities now conducted directly by the consumer. In these examples, very little information is actually required of the consumer and in each case, conditional or contingent activities by third parties outside of the transaction are not involved. The foregoing is also true of certain individual front-end tasks in the loan industry. For example, a consumer can submit an on-line request for a loan offer and receive bids from a number of intermediary brokers willing to manage the loan. The intermediary broker then proceeds to manage the loan in the traditional manner described above.

In the loan industry, however, due to the more complicated nature of a loan, the overall loan management process has continued to involve an intermediary. For example, in many home mortgage loans, an appraisal by an independent appraisal company is a necessary step in the loan application process. This requires that an appraisal company be contacted, certain information related to the property to be provided, an appraisal conducted, an appraisal report generated and the appraised value of the property be ascertained. The appraisal report then becomes a part of assemble information in the loan document package.

It is therefore desirable to provide an on-line process that permits consumers to manage their loan application without the need for an intermediary broker. The process should accommodate the need for conditional activities by third parties necessary for processing the loan. Furthermore, the process should accommodate the many variations that can arise from the specific set of parameters and data associated with a particular loan request.

### SUMMARY OF THE INVENTION

The present invention provides an innovative method by which consumers can manage their own loan processes. This brings a significant improvement to existing loan processes that are managed by brokers. Unlike existing systems, the scope of the present invention encompasses the entire loan process including applicant qualification, displaying and selecting qualified loan programs, selecting approved interest rates, selecting a title and appraisal company if real estate is involved, and submitting all documentation required for a complete, approved, and funded loan.

The method of the present invention utilizes a computer accessible by the consumer, a server network, and a communications network that connects the consumer's computer and the server network. As the loan application process proceeds, the consumer is prompted to provide progressively more detailed information, generally in three stages, which is progressively added to a consumer database associated with the consumer's loan application. In the first stage, the consumer provides only that data necessary for a credit bureau report to be obtained. In the second stage, the consumer provides only that data necessary to identify the loan programs for which the consumer would be eligible. In the third stage, the consumer provides the remaining data that would typically be required of by an automated underwriting system (AUS) in order to make a determination as to whether to fund the loan. Thus, one novel aspect of the invention is progressive information collection, wherein only the information necessary to perform the next step in the process is collected. In this way, the information provided by the consumer is minimized. Throughout the process, however, additional data may be collected from the consumer by requiring the consumer to fulfill certain tasks.

The overall process is driven by tasks drawn from a database of tasks typically required in the loan industry. The particular tasks required in a given loan application process are automatically identified based on any number of parameters associated with the loan request, such as, for example, the loan amount, the credit worthiness of the applicant, the type of loan, etc. Once a task for a given step in the loan process has been identified, the consumer database is searched and data relevant to the task is extracted.

Likewise, the server network also uses the communications network to access external, third-party databases that contain data such as credit reports, mortgage underwriting rules, and other necessary and helpful information owned by others. This information is also searched and such information is imported and added to the consumer database. Thereafter, a task list is interactively generated and presented to the consumer. For a particular task, the task list identifies all data required to complete the task that could not be gleaned or otherwise extracted from either the external third-party databases or the consumer database. The server network includes mainframes and other central processing units that communicate with the consumer as well as databases that maintain and store consumer data, loan programs, required actions, title company contact information, appraisal company contact information, current interest rates, monetary exchange rates, current-value data, and any other information that may be required for successful loan processing.

### BRIEF DESCRIPTION OF THE DRAWINGS

FIG. 1 is a flow diagram presenting an overall representation of the method of the present invention.

FIG. 2 is a flow diagram presenting the first stage of the application process associated with credit worthiness evaluation and the second stage of the application process associated with selection of a loan program.

FIG. 3 is flow diagram presenting the creation of a task list and the acquisition of data from the consumer responsive to the task list.

FIG. 4 is flow diagram presenting various possible tasks a consumer might be presented with in a mortgage loan application, including a module for obtaining a title document and a module for obtaining an appraisal.

FIG. 5 is flow diagram presenting another possible task a consumer might be presented with in a mortgage loan application, namely interest rate selection, and a flow diagram representing the consumer database update arising from performance of a task.

### DESCRIPTION OF THE PREFERRED EMBODIMENTS

In the detailed description of the invention, like numerals are employed to designate like parts throughout. Various items of equipment, such as fasteners, fittings, etc., may be omitted to simplify the description. However, those skilled in the art will realize that such conventional equipment can be employed as desired.

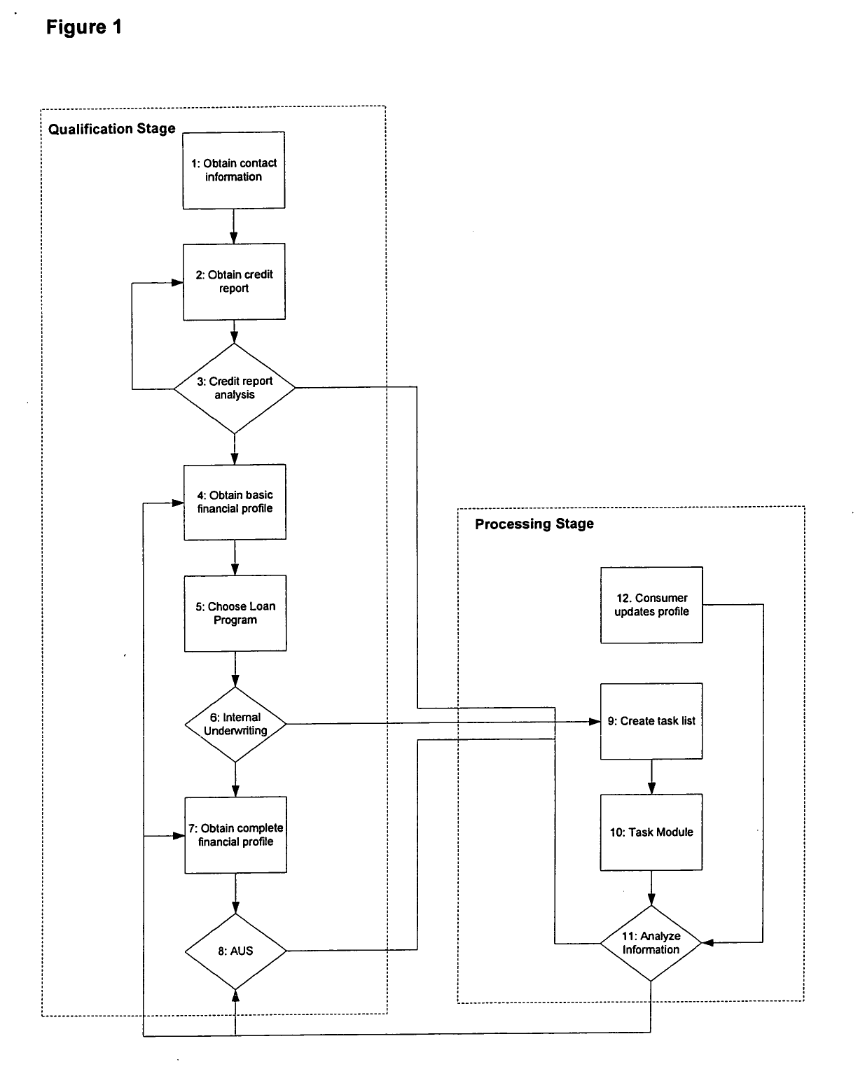

With reference to FIG. 1, in phase 1, the consumer uses a computer to access the host server through the Internet and to submit basic contact information and an authorization to examine a credit report. The host server stores such entered and retrieved information in a database resident in or local to the host.

In phase 2, the host accesses external credit reporting systems in order to obtain the consumer's credit report.

In phase 3, the host analyses the credit report and makes a determination of credit worthiness. If the host determines that the consumer's credit is deficient, the consumer is then directed to phase 9. If the host determines that the consumer's credit is sufficient, the system will then return to phase 2, obtain additional credit reports, return to phase 3, and make a final determination. In the final determination, the consumer's application is either moved to phase 9 if deficient or phase 4 if sufficient.

In phase 4, the consumer is prompted for additional financial information. This financial information includes information about the consumer's financial status sufficient to determine which loan programs are available. The host stores such information in a database resident in or local to the host.

In phase 5, the host analyzes the consumer's financial information, and, based on internal criteria, presents the consumer with a list of available loan programs. The consumer reviews the approved loan programs and makes a selection. This selection is made part of the consumer's profile by the host.

In phase 6, the host compares the consumer's financial information and selected loan program to an internal underwriting engine. Based on this determination, the consumer's application is moved to phase 9 (if not approved) or phase 7 (if approved).

In phase 7, the consumer is prompted for more financial information. This financial information includes sufficient information about the consumer's financial status to submit to automated underwriting systems.

In phase 8, the host communicates with automated underwriting systems, and transmits the consumer's financial and loan information. The automated underwriting systems will return results detailing approval status along with a list of requirements for loan completion.

In phase 9, the host analyzes the consumer's current loan progress, and generates a required task list. This task list is generated from the results of phases 3, 6, 8, and 11, depending on the stage of the loan process. The host compiles the required tasks and presents them to the consumer.

In phase 10, the consumer selects a task to complete. The host communicates to the consumer all requirements for the task including but not limited to submitting information, sending a document or documents (via website, email, fax, or postal mail), selecting an interest rate, selecting a title company and scheduling an appointment, or selecting an appraisal company and obtaining an appraisal.

In phase 11, drawing from internal databases, the host re-evaluates the consumer's loan profile. Based on the status of the loan, the system may send the loan file to an external underwriter or return to phase 9 to generate additional tasks.

In phase 12, the consumer requests a change to his profile. The system loads valid loan parameters in an editable form. The consumer changes data including but not limited to the loan program, interest rate, or loan amount. The consumer submits the changes via the form, and the host saves the updated profile to its database.

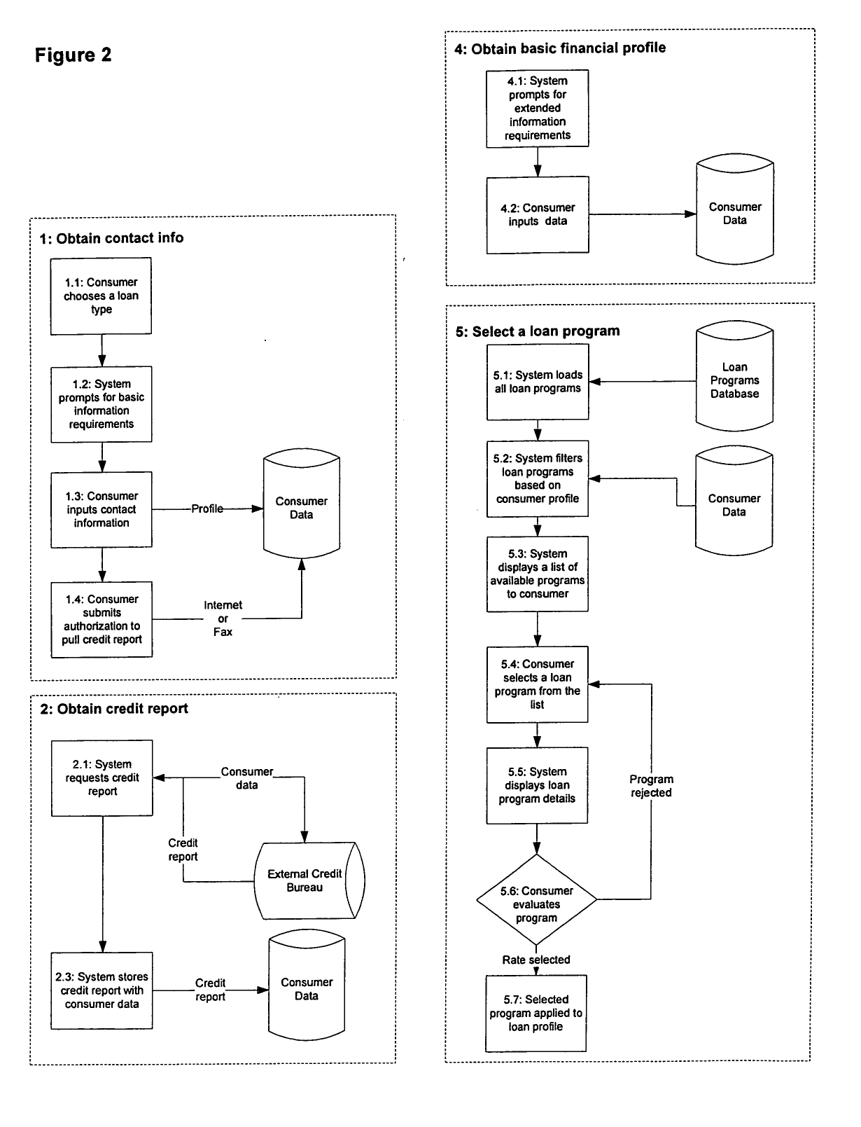

As the loan application process proceeds, the consumer is prompted to provide progressively more detailed information, generally in three stages, which is progressively added to a consumer database associated with the consumer's loan application. In the first stage, the consumer provides only that data necessary for a credit bureau report to be obtained. In the second stage, the consumer provides only that data necessary to identify the loan programs for which the consumer would be eligible. In the third stage, the consumer provides the remaining data that would typically be required of by an automated underwriting system (AUS) in order to make a determination as to whether to fund the loan. Thus, one novel aspect of the invention is progressive information collection, wherein only the information necessary to perform the next step in the process is collected. For example, phase 1 only collects sufficient consumer information necessary to obtain the credit report in phase 2. Additional information in the second stage is only collected if the credit reports indicate that a consumer is credit worthy. Likewise, phase 4 only collects sufficient information to permit a particular loan program to be selected (see FIG. 2, phase 5). Only if a particular loan program is available will the application process move on to phase 7 and the collection of all outstanding information. Phase 7 represents the bulk of the data to be collected that is generally necessary to complete a loan package for forwarding to the underwriter. This data may include documentation to support earlier data in the application and as required by the underwriter, such as for example only, bank statements, investment account statements, W-2 copies, documentation establishing employment and documentation establishing residence. In this way, the information provided by the consumer is minimized until it is necessary for the next step in the process. Notwithstanding these three stages of data collection, throughout the process, however, additional data may be collected from the consumer by requiring the consumer to fulfill certain tasks.

In this regard, the overall process is driven by tasks drawn from a database of tasks typically required in the loan industry. This may consist of hundreds of tasks if not more. The particular tasks required in a given loan application process are automatically identified based on any number of parameters associated with the loan request, such as, for example, the loan amount, the credit worthiness of the applicant, the type of loan, etc. The database of tasks may further include loan programs, required actions, title company contact information, appraisal company contact information, current interest rates, monetary exchange rates, current-value data, and any other information that may be required for successful loan processing. In any event, once a task for a given step in the loan process has been identified, the consumer database is searched and data relevant to the task is extracted.

Likewise, external, third-party databases are accessed to supplement the data required in a task. These external, third-party databases that contain available data such as credit reports, mortgage underwriting rules, and other necessary and helpful information owned by others. This external data may be specific to the consumer, such as the consumer's credit report, or may be unrelated to the consumer, such as underwriting rules for a particular AUS. In any event, this external information is also searched and relevant external information is imported and added to the consumer database. Thereafter, a task list is interactively generated and presented to the consumer. For a particular task, the task list identifies all data required to complete the task that could not be gleaned or otherwise extracted from either the external third-party databases or the consumer database. Of course, those skilled in the art will understand that some tasks will simply require the consumer to make a selection between various choices, whereas other tasks may require the consumer to submit data, such as documentation. Those the scope and complexity of the tasks will vary.

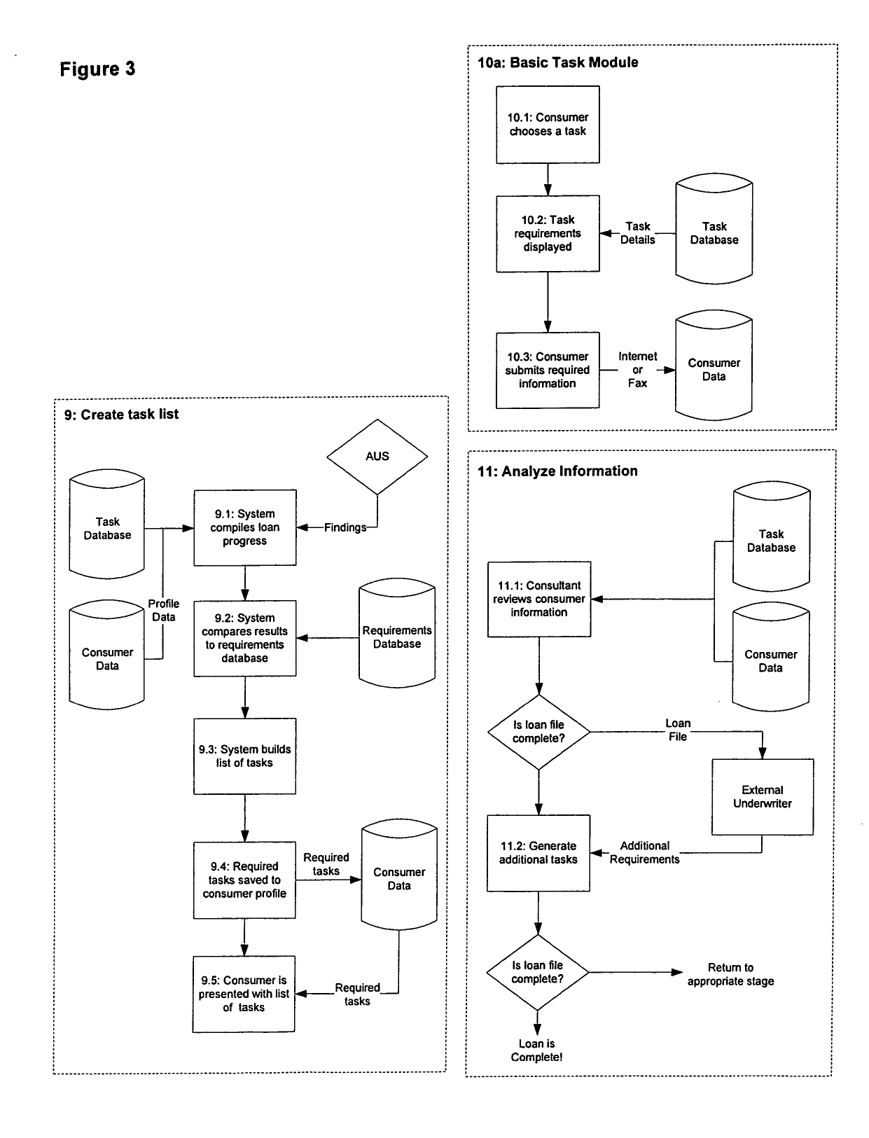

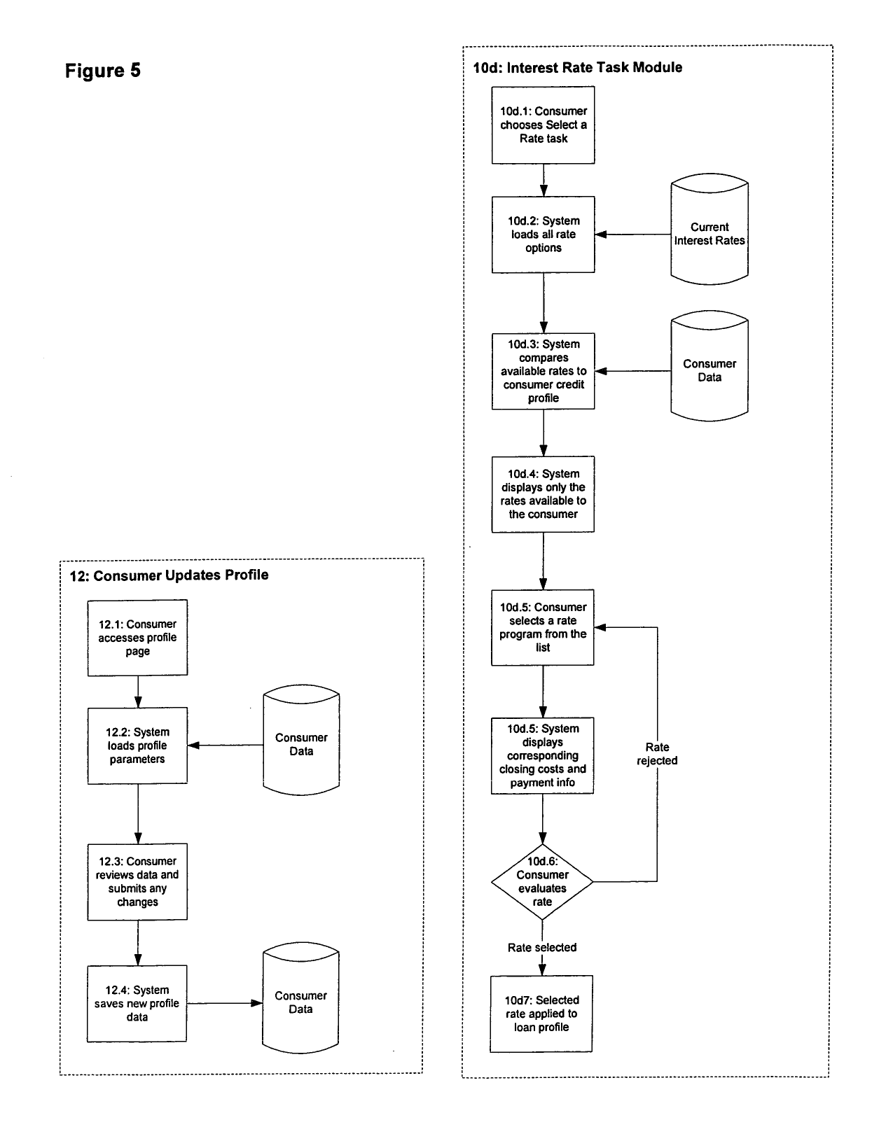

FIGS. 2 through 5 illustrate, in flow diagram format, some of the individual functions (blocks) illustrated in FIG. 1. The omitted functions are commonly understood in the loan industry. In phase 5 for example, illustrated in FIG. 2, a loan program database is maintained. Upon the receipt of consumer data set in phase 4 of the process, the system identifies all of the loans from the loan program database for which the consumer would be eligible. The consumer is then presented with the eligible loans and requested to select a specific loan. The loan program database includes information that would permit the consumer to compare various loan programs to select the loan program most appropriate for the consumer based on the consumer's individual requirements. Thereafter, the consumer database is updated to include the selected loan program.

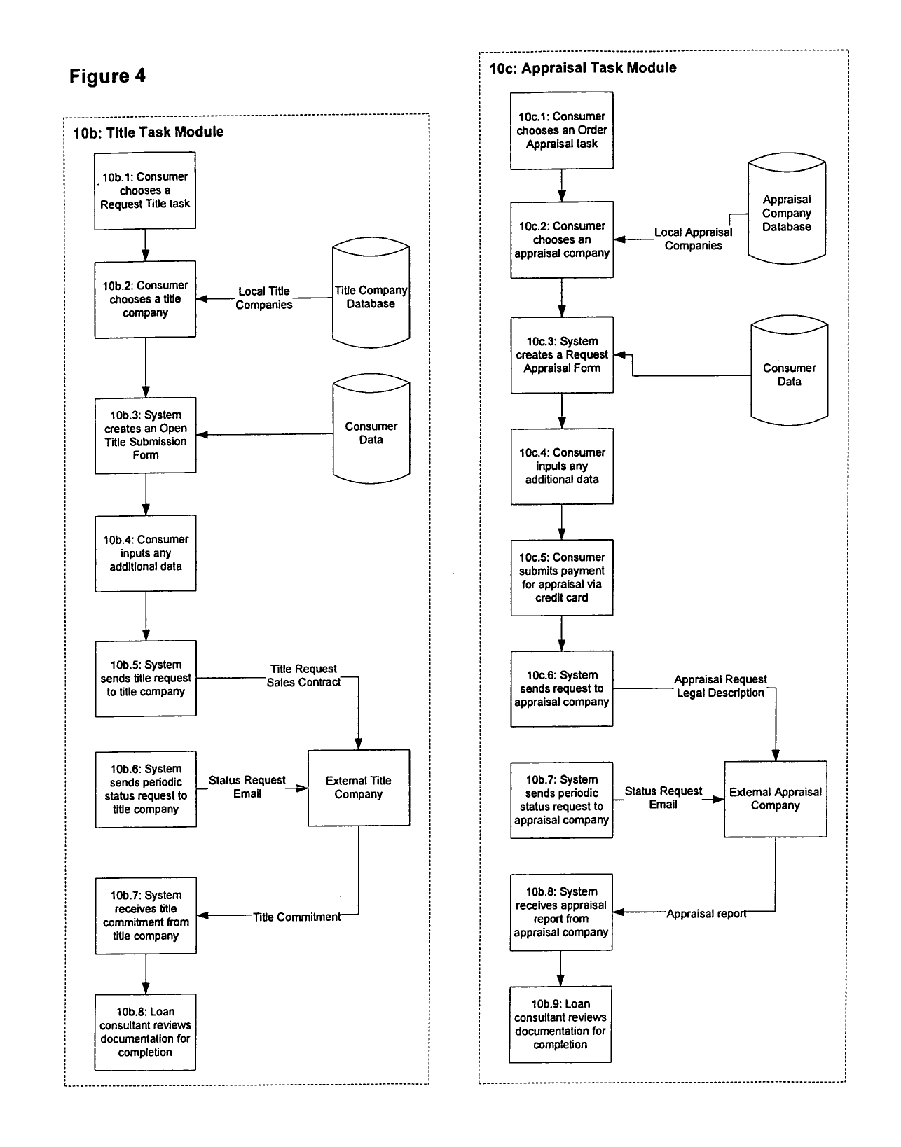

In phase 10 of FIG. 4, a database is maintained of businesses that perform certain conditional or contingent external activities related to the loan, such as obtaining title for a loan or obtaining an appraisal for a loan. The consumer is prompted for information to identify the businesses that would be most appropriate to provide these activities. In one embodiment, for example, a consumer is prompted for a zip code or a specific property address and all of the appropriate businesses located in or near the zip code or near the address are identified. Of course, other consumer inputted information may be used to filter such businesses as well. In any event, it is the consumer who ultimately chooses the most appropriate businesses based on the consumer's individual requirements.

It will be apparent to those with ordinary skill in the relevant art having the benefit of this disclosure that the present invention provides a method that permits consumers to interactively qualifying for, manage and process loans over the Internet without the need for intermediary brokers. An additional benefit is that the method permits consumers to readily track progress of their loan application. It is understood that the forms of the invention shown and described in the detailed description and the drawings are to be taken merely as presently preferred examples and that the invention is limited only by the language of the claims. The drawings and detailed description presented herein are not intended to limit the invention to the particular embodiment disclosed. The method disclosed and claimed herein could be utilized for mortgages, vehicle loans, or any other type of loan that requires qualification and processing.

While the present invention has been described in terms of one preferred embodiment, it will be apparent to those skilled in the art that form and detail modifications can be made to that embodiment without departing from the spirit or scope of the invention.

What is claimed is:

1. A method whereby consumers can interactively and directly process a loan request over the Internet through progressive information collection, said method comprising the steps of:
providing an Internet web site accessible by a consumer interested in receiving a loan, wherein the web site is capable of receiving information from the consumer and provide the consumer with tasks as a loan request is processed;
creating a consumer database associated with the consumer;
prompting the consumer to provide a first set of loan information;
populating a consumer database with the first set of loan information;
obtaining authorization from the consumer to access an external credit report associated with the consumer;
based on said first set of loan information, automatically accessing via the Internet a first credit report associated with said consumer and generated by a first external credit bureau;
automatically evaluating said first credit report to determine credit worthiness of the consumer;
based on the evaluation of said first credit report, automatically accessing via the Internet at least one additional credit report generated by a second external credit bureau;
automatically evaluating said second credit report to determine credit worthiness of the consumer;
based on the evaluation of said second credit report, prompting the consumer to provide a second set of loan information;
updating the consumer database to include the second set of loan information;
based on said second set of loan information, automatically determining what external loan programs are available to the consumer;
prompting the consumer to select a specific loan program from the available loan programs previously determined based on the second set of loan information;
making a first internal determination as to whether the second set of loan information satisfies underwriting guidelines associated with the specific loan program;
based on the first internal evaluation, prompting the consumer to provide a third set of loan information;
updating the consumer database to include the third set of loan information;
automatically providing at least a portion of the first, second and third set of loan information to an outside banking institution;
receiving from the outside banking institution a list of requirements for loan completion;
generating a loan fulfillment task list comprised of individual tasks a consumer must fulfill in order to complete a loan;
presenting the loan fulfillment task list to the consumer at the web site;
prompting the consumer to verify that a task in the loan fulfillment task list has been completed;
verifying that all tasks in the loan fulfillment task list have been completed;
creating a loan file based on foregoing completed tasks;
upon completion of the foregoing tasks, forwarding the loan file to the outside banking institution.

2. The method of claim 1, wherein the first set of loan information comprises only sufficient data necessary to obtain the first credit report.

3. The method of claim 1, wherein the step of evaluating the first credit report comprises assigning a score to the credit report based on data contained in the credit report.

4. The method of claim 3, wherein the score is above a predetermined based score.

5. The method of claim 3, further comprising the following steps when the score is below a predetermined base score:
generating a credit worthiness task list comprised of individual tasks a consumer must fulfill in order to have the consumer's credit worthiness re-evaluated;
presenting the task list to the consumer at the web site;
prompting the consumer to verify that a task has been completed;
verifying that all tasks in the credit worthiness task list have been completed;
re-evaluating said first credit report based on said completed tasks.

6. The method of claim 4, wherein said predetermined base score is 620.

7. The method of claim 5, wherein said predetermined base score is 620.

8. The method of claim 1, wherein at least two additional credit reports are automatically accessing via the Internet.

9. The method of claim 8, wherein one additional credit report is generated by a second external credit bureau and one additional credit report is generated by a third external credit bureau.

10. The method of claim 1, wherein the step of evaluating the additional credit report comprises assigning a score to the additional credit report based on data contained in the additional credit report.

11. The method of claim 10, wherein the score is above a predetermined based score.

12. The method of claim 10, further comprising the following steps when the score is below a predetermined base score:
generating a credit worthiness task list comprised of individual tasks a consumer must fulfill in order to have the consumer's credit worthiness re-evaluated;
presenting the task list to the consumer at the web site;
prompting the consumer to verify that a task has been completed;
verifying that all tasks in the credit worthiness task list have been completed;
re-evaluating said additional credit report based on said completed tasks.

13. The method of claim 11, wherein said predetermined base score is 620.

14. The method of claim 12, wherein said predetermined base score is 620.

15. The method of claim 1, wherein the steps of evaluating the credit reports comprises assigning an individual score to each credit report based on data contained in the credit report, said method further comprising the step of determining an average score for the credit reports based on said individual scores.

16. The method of claim 15, wherein the average score is above a predetermined average based score.

17. The method of claim 16, wherein said predetermined average base score is 620.

18. The method of claim 1, wherein the second set of loan information comprises only sufficient data necessary to identify the type of loan the consumer desires.

19. The method of claim 1, wherein the second set of loan information includes parameters associated with the type of loan the consumer desires.

20. The method of claim 19, wherein one of said parameters is the term of the loan.

21. The method of claim 19, wherein one of said parameters is the interest rate of the loan.

22. The method of claim 19, wherein one of said parameters is the monthly payment amount for the loan.

23. The method of claim 19, wherein one of said parameters is the adjustable nature of the loan.

24. The method of claim 1, further comprising the steps of identifying underwriting guidelines of an outside banking institution associated with the specific loan program.

25. The method of claim 1, wherein the step of making a first internal determination as to whether the second set of loan information satisfies underwriting guidelines associated with the specific loan program comprises:
identifying underwriting guidelines of an outside banking institution associated with the specific loan program;
utilizing said first and second sets of loan information to internally determine if the underwriting guidelines associated with the specific loan program are satisfied by the data contained in said first and second sets of loan information.

26. The method of claim 25, further comprising the following steps when the underwriting guidelines are not satisfied by the data contained in said first and second sets of loan information:
generating an underwriting task list comprised of individual tasks a consumer must fulfill in order to provide data expected to satisfy the underwriting guidelines;
presenting the task list to the consumer at the web site;
receiving data associated with a specific task on the task list;
verify that a task has been completed; and
verifying that all tasks in the underwriting task list have been completed.

27. The method of claim 1, further comprising the sets of receiving a request for information from the outside banking institution based on said loan file.

28. The method of claim 27, further comprising the step of generating a loan fulfillment task list comprised of individual tasks a consumer must fulfill in order to receive a loan from the outside banking institution;
presenting the task list to the consumer at the web site;
receiving data associated with a specific task on the task list;
verify that a specific task has been completed;
verifying that all tasks in the loan fulfillment task list have been completed;
transmitting the received data associated with the task list to the outside banking institution.

29. The method of claim 1, wherein the step of generating a loan fulfillment task list comprises:
Creating a task database of tasks commonly associated with a loan,
Identifying a specific task required in the loan process;
Identifying the data necessary to complete a specific task;
Comparing the data necessary to complete a specific task with the data in the consumer database;
Generating a task list that sets forth each task for which data necessary to complete the task does not appear in the consumer database;
Associating the task list with the consumer database; and
Presenting the task list to the consumer at the web site.

30. The method of claim 29, further comprising:
Prompting the consumer to select a specific task;
Presenting the consumer with missing data that does not appear in the consumer database that is necessary to fulfill the selected specific task;
Receiving from the consumer the missing data; and
Updating the consumer database to include the missing data.

31. The method of claim 30 wherein the missing data is copies of the consumer's financial records.

32. The method of claim 30, wherein the missing data is copies of the consumer's employment records.

33. The method of claim 29, wherein the task is obtaining an appraisal.

34. The method of claim 29, wherein the task is obtaining an appraisal for at least a predetermined value.

35. The method of claim 29, wherein the task is selecting a title company.

36. The method of claim 29, wherein the task is selecting an interest rate.

37. The method of claim 1, further comprising the step of creating a task list associated with at least one step of the process.

38. The method of claim 37, wherein the step of creating a task list comprises:
Creating a task database of tasks commonly associated with a loan,
Identifying a specific task required in the loan process;
Identifying the data necessary to complete a specific task;
Comparing the data necessary to complete a specific task with the data in the consumer database;
Generating a task list that sets forth each task for which data necessary to complete the task does not appear in the consumer database;
Associating the task list with the consumer database; and
Presenting the task list to the consumer at the web site.

39. The method of claim 38, further comprising:
Prompting the consumer to select a specific task;
Presenting the consumer with missing data that does not appear in the consumer database that is necessary to fulfill the selected specific task;
Receiving from the consumer the missing data; and
Updating the consumer database to include the missing data.

40. The method of claim 39 wherein the missing data is copies of the consumer's financial records.

41. The method of claim 39, wherein the missing data is copies of the consumer's employment records.

42. The method of claim 38, wherein the task is obtaining an appraisal.

43. The method of claim 38, wherein the task is obtaining an appraisal for at least a predetermined value.

44. The method of claim 38, wherein the task is selecting a title company.

45. The method of claim 38, wherein the task is selecting an interest rate.

46. A method whereby consumers can interactively and directly process a loan request over the Internet through progressive information collection, said method comprising the steps of:
providing an Internet web site accessible by a consumer interested in receiving a loan, wherein the web site is capable of receiving information from the consumer and provide the consumer with tasks as a loan request is processed;
creating a consumer database associated with the consumer;
a first stage comprising
prompting the consumer to provide a first set of loan information;
populating a consumer database with the first set of loan information;
obtaining authorization from the consumer to access an external credit report associated with the consumer;
based on said first set of loan information, automatically accessing via the Internet a first credit report associated with said consumer and generated by a first external credit bureau;
automatically evaluating said first credit report to determine credit worthiness of the consumer;
a second stage comprising:
based on the evaluation of said credit report, prompting the consumer to provide a second set of loan information;
updating the consumer database to include the second set of loan information;
based on said second set of loan information, automatically determining what external loan programs are available to the consumer;
prompting the consumer to select a specific loan program from the available loan programs previously determined based on the second set of loan information;
making a first internal determination as to whether the second set of loan information satisfies underwriting guidelines associated with the specific loan program;
a third stage comprising:
based on the first internal evaluation, prompting the consumer to provide a third set of loan information, wherein said loan information includes documentation to support the loan request;
updating the consumer database to include the third set of loan information;
creating a loan file based on foregoing loan information;
upon completion of the foregoing tasks, forwarding the loan file to the outside banking institution; and
creating a task list associated with at least one step of the stages, wherein the step of creating a task list comprises:
Creating a task database of tasks commonly associated with a loan,
Identifying a specific task required in the requested loan process;
Identifying the data necessary to complete a specific task;
Comparing the data necessary to complete a specific task with the data in the consumer database;
Retrieving from an external third party database available external data necessary to complete a specific task;
Generating a task list that sets forth each task for which data necessary to complete the task does not appear in the consumer database or from available external data;
Associating the task list with the consumer database; and
Presenting the task list to the consumer at the web site.

47. The method of claim 46, further comprising:
Prompting the consumer to select a specific task;
Presenting the consumer with missing data that does not appear in the consumer database or in available external data that is necessary to fulfill the selected specific task;
Receiving from the consumer the missing data; and
Updating the consumer database to include the missing data.
